(19) United States
(12) Patent Application Publication
(10) Pub. No.: US 2019/0362339 A1
(43) Pub. Date: Nov. 28, 2019

(54) METHODS AND SYSTEMS FOR FACILITATING PAYMENT TRANSACTION USING A PREFERRED DIGITAL WALLET APPLICATION

(71) Applicant: Mastercard International Incorporated, Purchase, NY (US)

(72) Inventors: Arunmurthy Gurunathan, Pune (IN); Ganesh Shinde, Pune (IN); Ravi Pareek, Pune (IN)

(73) Assignee: Mastercard International Incorporated, Purchase, NY (US)

(21) Appl. No.: 16/374,788

(22) Filed: Apr. 4, 2019

(30) Foreign Application Priority Data
May 25, 2018 (SG) 10201804465Y

(51) Int. Cl. G06Q 20/36

(52) U.S. Cl. CPC G06Q 20/363; G06Q 20/3674

(57) ABSTRACT

Embodiments provide methods, and server systems for facilitating payment transaction using a preferred digital wallet application. In an embodiment, the method includes receiving, by a server system, a unique reference number associated with a payment card linked with a plurality of digital wallet applications of a user on an e-commerce website for making a payment transaction. The method includes accessing a mapping database to extract the plurality of digital wallet applications using the unique reference number. The method includes selecting a preferred digital wallet application based on a type of the payment transaction and at least one predefined criteria being usage information of each digital wallet application. The method includes facilitating a display of the preferred digital wallet application on a user device of the user. Upon receiving a user approval of the preferred digital wallet application, the method includes performing the payment transaction through the preferred digital wallet application.

### CROSS REFERENCE TO RELATED APPLICATIONS

This application claims priority to Singaporean Application Serial No. 10201804465Y, filed May 25, 2018, which is incorporated herein by reference in its entirety

### TECHNICAL FIELD

The present disclosure relates to payment transactions using digital wallet applications on e-commerce websites and, more particularly to, methods and systems for facilitating payment transaction using a preferred digital wallet application.

### BACKGROUND

Generally, while performing a digital financial transaction (e.g., payment transaction), the consumer/user is needed to enter all the payment card details of his/her payment card such as credit card, debit card, prepaid card, etc., on the merchant terminal. This is a time consuming and not very secure payment method as there is a risk of misuse of the payment card details. Alternatively, consumers digitize their payment cards into the mobile phones, wearable devices, tablets etc., using technologies such as tokenization, Card-on-File (COF) transactions, digital wallet platforms and the like for performing digital financial transactions. Tokenization allows user to digitize his/her existing payment cards into a mobile phone or other devices using a digital token and use the token at various merchant terminals such as an e-commerce website, a point-of-sale (POS) terminals, contactless payments etc.

Digital payment industry is moving towards providing better user experience for both consumers and merchants. Nowadays, there exists multiple digital wallet platforms (hereinafter referred to as wallet platforms) that facilitate dedicated digital wallet applications (hereinafter referred to as wallet applications) using which the user can perform safe and secure payment transactions. In addition to tokenizing the payment card, such platforms offer various reward functions, discounts and the like for promoting their usage. In the scenario, when the user is using multiple wallet applications in various user devices, the user is required to keep track of all the payment transactions made through all such wallet applications as they provide different user benefits. Further, it is possible that one payment card is linked with multiple wallet applications. This adds on to a tracking of the payment card usage which may result in frustrating user experiences.

Accordingly, there is a need for techniques that enable safe and secure digital payment transactions where user does not need to enter actual payment card details for every transaction. Further, there is a need for techniques that provide an effective way to select a preferred wallet application from the multiple wallet applications present in various user devices for performing the payment transactions.

### SUMMARY

Various embodiments of the present disclosure provide systems, methods, electronic devices and computer program products to facilitate payment transaction using a preferred digital wallet application.

In an embodiment, a computer-implemented method is disclosed. The method includes receiving, by a server system associated with a payment network, a unique reference number from a user on an e-commerce website for making a payment transaction. The unique reference number is associated with a payment card linked with a plurality of digital wallet applications of the user. The method includes accessing a mapping database to extract the plurality of digital wallet applications using the unique reference number. The method includes selecting a preferred digital wallet application based on a type of the payment transaction and at least one predefined criteria. The at least one predefined criteria is usage information of each digital wallet application of the plurality of digital wallet applications. Moreover, the method includes facilitating a display of the preferred digital wallet application on a user device of the user. Upon receiving a user approval of the preferred digital wallet application, the method includes performing the payment transaction through the preferred digital wallet application.

In another embodiment, a server system in a payment network is provided. The server system includes a communication interface configured for receiving a unique reference number from a user on an e-commerce website for making a payment transaction. The unique reference number is associated with a payment card linked with a plurality of digital wallet applications of the user. The server system includes a memory comprising executable instructions and a processor communicably coupled to the communication interface. The processor is configured to execute the instructions to cause the server system to at least access a mapping database to extract the plurality of digital wallet applications using the unique reference number. The server system is further caused to select a preferred digital wallet application based on a type of the payment transaction and at least one predefined criteria. The at least one predefined criteria is usage information of each digital wallet application of the plurality of digital wallet applications. The server system is further caused to facilitate a display of the preferred digital wallet application on a user device of the user. Upon receiving a user approval of the preferred digital wallet application, the server system is further caused to perform the payment transaction through the preferred digital wallet application.

In yet another embodiment, a server system in a payment network is provided. The server system includes a memory comprising executable instructions and a processor communicably coupled to a communication module. The processor is configured to execute the instructions to cause to the server system to facilitate, via the communication module, a display of an e-commerce website configured to include a plurality of payment methods for user selection on a user interface (UI) of a user device for making a payment transaction. At least one payment method of the plurality of the payment methods includes a unique reference number based payment transaction. The unique reference number is associated with a payment card linked with a plurality of digital wallet applications of a user. The server system is further caused to receive, via the communication module, a transaction amount and the unique reference number from the user on the UI for making the payment transaction through a selection of the unique reference number based payment transaction. The server system is further caused to facilitate the payment transaction through a preferred digital wallet application selected from the plurality of digital wallet applications of the user using the unique reference number.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, related to at least some example embodiments of the present disclosure;

FIG. 2 represents a sequence flow diagram representing a completion of a payment transaction using a unique virtual card number, in accordance with an example embodiment;

FIG. 3 represents a sequence flow diagram representing a completion of a payment transaction using a platform ID, in accordance with another example embodiment;

FIG. 4A is a simplified schematic representation of an example User Interface (UI) of an e-commerce website configured to display a payment method of unique reference number based payment transaction on a user device, in accordance with an example embodiment;

FIG. 4B is a simplified schematic representation of an example User Interface (UI) of an e-commerce website configured to display a preferred digital wallet application for making a payment transaction on a user device, in accordance with an example embodiment;

FIG. 5 is a simplified schematic representation of a mapping database configured to store wallet information of a plurality of digital wallet applications of a user, in accordance with an example embodiment;

FIG. 6 illustrates a flow diagram of a method for facilitating payment transaction using a preferred digital wallet application, in accordance with an example embodiment;

FIG. 7 is a simplified block diagram of a server system configured to facilitate payment transaction using a preferred digital wallet application, in accordance with one embodiment of the present disclosure;

FIG. 8 is a simplified block diagram of a digital wallet server used for payment transaction using a preferred digital wallet application, in accordance with one embodiment of the present disclosure;

FIG. 9 is a simplified block diagram of an issuer server used for payment transaction using a preferred digital wallet application, in accordance with one embodiment of the present disclosure;

FIG. 10 is a simplified block diagram of an acquirer server used for payment transaction using a preferred digital wallet application, in accordance with one embodiment of the present disclosure;

FIG. 11 is a simplified block diagram of a payment server used for payment transaction using a preferred digital wallet application, in accordance with one embodiment of the present disclosure; and

FIG. 12 shows simplified block diagram of a user device capable of implementing at least some embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account” used throughout the description refer to a financial account that is used to fund the financial transaction (interchangeably referred to as “payment transaction”). Examples of the payment account include, but is not limited to a savings account, a credit account, a checking account and a virtual payment account. The payment account may be associated with an entity such as an individual person, a family, a commercial entity, a company, a corporation, a governmental entity, a non-profit organization and the like. In some scenarios, a payment account may be a virtual or temporary payment account that can be mapped or linked to a primary payment account, such as those accounts managed by PayPal®, and the like.

The term “payment network”, used throughout the description, refer to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

The term “payment card”, used throughout the description, refers to a physical or virtual card linked with a financial or payment account that may be used to fund a financial transaction to a merchant or any such facility via the associated payment account. Examples of the payment card include, but are not limited to, debit cards, credit cards, prepaid cards, virtual payment numbers, virtual card numbers, forex cards, charge cards and stored-value cards. A payment card may be a physical card that may be presented to the merchant for funding the payment. Alternatively, or additionally, the payment card may be embodied in form of data (e.g., a digital token) stored in a user device, where the data is associated with payment account such that the data can be used to process the financial transaction between the payment account and a merchant's financial account.

The term ‘unique reference number’ used throughout the description refers to one or more combinations of numbers, characters, alpha-numeric characters etc., which can typically be generated by a bot and/or by a manual operation, or may be a string based on a known identifier associated with the user. For example, the unique reference number may be a unique virtual card number, a user identifier, or device identifier of the user device (e.g., a platform ID of the user device) which can be used at various merchant interfaces such as in-app purchases, online purchases etc.

The term ‘e-commerce website’ used throughout refers to any web portal, web page, mobile or web application, which are used for buying and selling of good and/or services, or for performing any such payment or business transaction, over an electronic network such as the Internet. The e-commerce website can cater to business-to-business, business-to-consumer, consumer-to-consumer or consumer-to-business. Some examples of the e-commerce website include web portal or web or mobile applications of Amazon®, eBay®, Paypal®, Walmart®, and the like.

Overview

Various example embodiments of the present disclosure provide methods, systems, user devices and computer program products for facilitating payment transactions using preferred digital wallet applications.

In various example embodiments, the present disclosure provides a server system configured to receive a unique reference number associated with a payment card linked with a plurality of digital wallet applications (hereinafter referred to as wallet applications) of a user on an e-commerce website for making a payment transaction. In various embodiments, the unique reference number is a unique virtual card number or a platform ID of the user which can be used at various merchant interfaces such as in-app purchases, online purchases etc. In one embodiment, the unique reference number is received from an acquirer server (an example of the server system) along with a transaction amount of the prospective payment transaction.

The acquirer server sends the unique reference number to an interchange server (i.e. a payment server, an example of the server system) for processing the payment transaction. The payment server accesses a mapping database to extract the wallet applications using the unique reference number. The payment server also selects a preferred wallet application based on a type of the payment transaction and predefined criteria. Examples of the predefined criteria relate to usage information of each digital wallet application including, but not limited to, usage information of each wallet application, a purchase history, one or more rewards offered by each wallet application, a network bandwidth utilization, a battery usage of the user device and the like. The payment server updates the mapping database on a predetermined periodic basis with wallet information of each wallet application against the unique reference number. Some non-exhaustive examples of the wallet information include an identifier of the user device, the platform ID of the user, a name of the wallet application, a digital token generated by the wallet application for the payment card, a wallet application platform and a current status of the wallet application determined based on the type of the payment transaction and the predefined criteria.

In one embodiment, the payment server notifies to a digital wallet server (hereinafter referred to as wallet server, an example of the server system) of the selected preferred wallet application using the digital token generated by that wallet server for the payment card. The wallet server facilitates a display of the preferred wallet application on the user device for user approval. Upon receiving the user approval, the payment transaction is facilitated. In at least one embodiment, the user is given a prime authority to decline the displayed preferred wallet application and provide a user preference of selecting another wallet application to complete the payment transaction. In such scenarios, the server system is configured to display the preferred wallet application based on the user preferences on the user device and perform the payment transaction.

The payment server extracts payment card information of the payment card associated with the unique reference number and sends it to an issuer server (an example of the server system) for authorization. The payment server may also send the transaction amount to the issuer server to verify sufficient funds present in an issuer account of the user. Once, the payment server receives confirmation of authorization of the payment card information from the issuer server, the payment server completes the payment transaction from the issuer account of user to the merchant account.

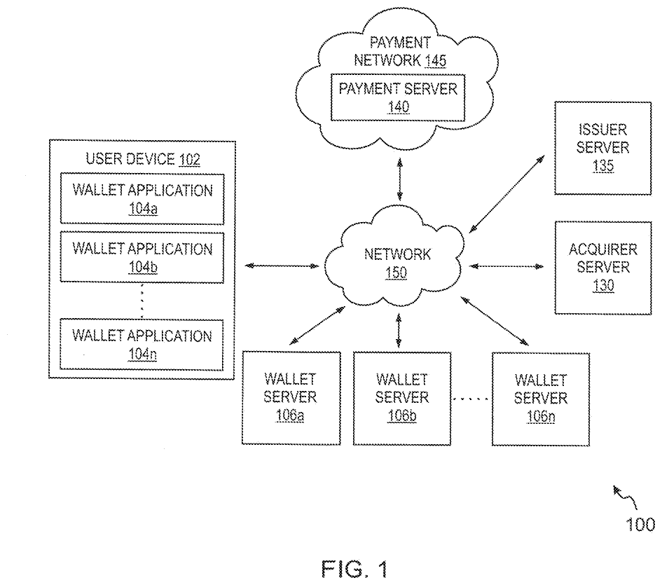

FIG. 1 illustrates an example representation of an environment 100, in which at least some example embodiments of the present disclosure can be implemented. A user device 102 of a user (not shown) is shown to have installed a plurality of digital wallet applications such as a digital wallet application 104a, a digital wallet application 104b . . . a digital wallet application 104n (hereinafter referred to as wallet applications 104a-n). It should be noted that some of the wallet applications of the plurality of digital wallet applications may not be necessarily installed on the user device 102, even if the user has an active account on such wallet applications. However, the user may use these wallet applications through means such as web portals, tokens, web links, etc. Examples of the user device 102 include, but are not limited to, a personal computer (PC), a mobile phone, a tablet device, a Personal Digital Assistant (PDA), a voice activated assistant, a Virtual Reality (VR) device, a smartphone and a laptop. The wallet applications 104a-n are facilitated by their respective digital wallet servers such as a digital wallet server 106a, a digital wallet server 106b . . . a digital wallet server 106n (hereinafter referred to as wallet servers 106a-n) through various digital platforms. Some non-exhaustive examples of the wallet applications 104a-n include Apple Pay®, Samsung Pay®, Google Pay™, bank wallet applications and the like. Examples of various digital wallet platforms such as Google®, Samsung®, Apple®, Microsoft wallet, various issuer banks and the like.

The wallet servers 106a-n are configured to generate respective digital tokens (hereinafter referred to as tokens) for various payment cards of the user or any other funding source of the user through a tokenization process. The wallet platforms provide mobile and web applications using which the users can generate the tokenization request of their payment cards as well as use the generated digital tokens for digital payments at the merchant interfaces. The wallet applications 104a-n are configured to display various form fields (not shown) to be filled by the user such as a payment card number (e.g., xxxx xxxx xxxx xxxx where ‘x’ is an integral number) of the payment card, expiry date (e.g., MM/YY, month and year of expiry), Card Verification Value (CVV) number (e.g., *** where * is an integral number) and the like while tokenizing a payment card. The tokens include tokenized card information of the payment card of the user. In a non-limiting example, the token is a numeric code of variable length (13 to 19 digits).

In one example embodiment, the wallet servers 106a-n may store the respective wallet applications 104a-n and provision instances of the applications to end-users on their respective user devices for facilitating the payment transactions using the tokens. For example, the end-users may request the wallet server 106a to provision access to the wallet application 104a over a network 150. The instances of the application may thereafter be downloaded on the user devices (such as the user device 102) of the respective end-users in response to their request for access to the wallet application 104a. Alternatively, in some embodiments, the wallet application 104a may be factory installed within the user devices associated with the end-users and, as such, the users may not need to explicitly request the wallet application 104a from the wallet server 106a.

In a non-limit example, the process of tokenization of the payment card, generation of the unique reference number and completion of the payment transaction using a preferred wallet application using the unique reference number is facilitated by a combination of the wallet servers 106a-n, a payment server 140, an issuer server 135 and an acquirer server 130. In one embodiment, the payment server 140 is associated with a payment network 145. The payment network 145 may be used by the payment cards issuing authorities as a payment interchange network. Examples of payment interchange network include, but not limited to, Mastercard® payment system interchange network. The Mastercard® payment system interchange network is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.). Further, Mastercard Digital Enablement Service (MDES) is a service/a tokenization platform facilitated by Mastercard® payment system interchange network that allows issuers, registered users, token requestors (e.g., the wallet servers 106a-n) and merchants to turn the payment card numbers into digital tokens for secure digital payment transactions. In an embodiment, the wallet servers 106a-n register with the payment server 140/MDES in order to facilitate payment transaction using the digital tokens.

The issuer server 135 is associated with a financial institution normally called as an “issuer bank” or “issuing bank” or simply “issuer”, in which the user may have an account, which issues a payment card, such as a credit card or a debit card. The issuer server 135 also facilitates authorization of the payment card information associated with the payment card of the user for completing a payment transaction.

To accept payment using the unique reference number based payment transaction, the merchant (not shown) must normally establish an account with a financial institution that is part of the financial payment system. This financial institution is usually called the “merchant bank” or the “acquiring bank” or “acquirer bank” or simply “acquirer”. The acquirer server 130 is associated with the acquirer bank.

Using the payment network 145, the computers of the acquirer/the acquirer server 130 or the merchant processor communicate with the computers of the issuer/the issuer server 135 to determine whether the user's account is in good standing and whether the purchase is covered by the user's available account balance. Based on these determinations, authorization of the payment transaction is declined or accepted. When the authorization is accepted, the available balance of the user's account is decreased. Normally, a charge is not posted immediately to a user's account because bankcard associations, such as Mastercard International Incorporated®, have promulgated rules that do not allow a merchant to charge, or “capture,” a transaction until goods are shipped or services are delivered. When the merchant ships or delivers the goods or services, the merchant captures the transaction by, for example, appropriate data entry procedures on the point-of-sale (POS) terminal. If a user cancels a transaction before it is captured, a “void” is generated. If the user returns goods after the transaction has been captured, a “credit” is generated.

After a transaction is captured, the transaction is settled between the merchant, the acquirer and the issuer. Settlement refers to the transfer of financial data or funds between the merchant's account, the acquirer, and the issuer, related to the transaction. Usually, transactions are captured and accumulated into a “batch”, which is settled as a group.

The user device 102, a merchant interface (e.g., e-commerce website, not shown), the issuer server 135, the acquirer server 130, the wallet servers 106a-n and the payment server 140 communicate with one another using the network 150. Examples of the network 150 may include any type of wired network, wireless network, or a combination of wired and wireless networks. A wireless network may be a wireless local area network (“WLAN”), a wireless wide area network (“WWAN”), or any other type of wireless network now known or later developed. Additionally, the network 150 may be or include the Internet, intranets, extranets, microwave networks, satellite communications, cellular systems, public cloud platforms (e.g., Amazon Web Services (AWS), Microsoft's Azure, and Google Cloud Platform), personal communication services (“PCS”), infrared communications, global area networks, or other suitable networks, etc., or any combination of two or more such networks.

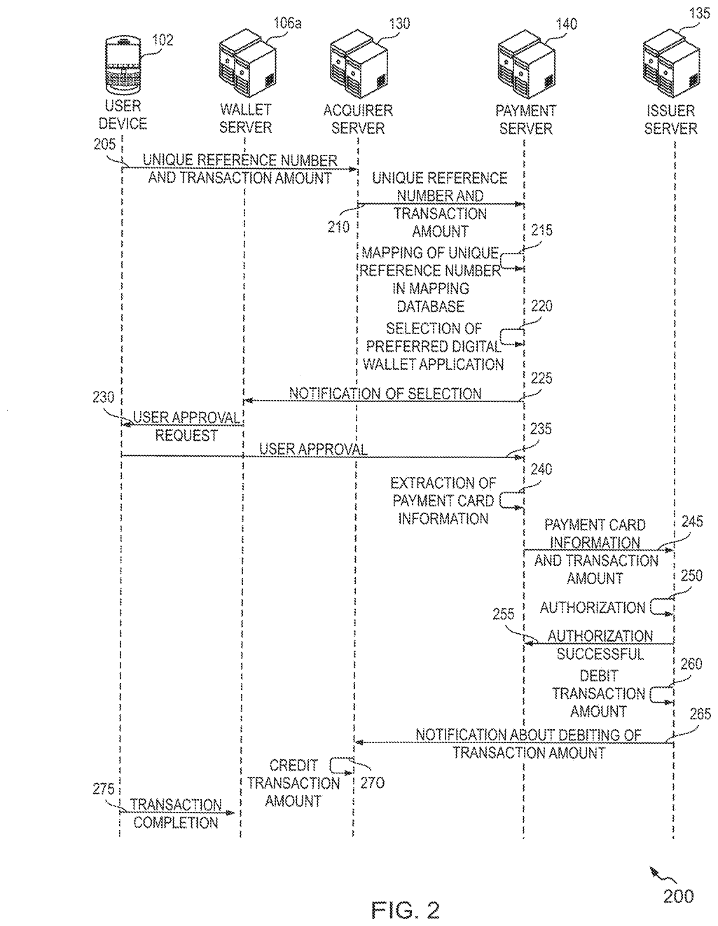

Since the user is needed to only enter a unique reference number for making a payment to the merchant, the overall transaction flow is effortless for completing the payment transaction. In existing (conventional) payment transaction methods (i.e., not in accordance with the present disclosure), the user is either required to share the original payment card information of the payment card on the merchant interface or keep track of the usage of the payment card linked with a plurality of wallet applications. In contrast to existing payment transaction methods, by using the embodiments of the present disclosure, the user is only required to enter the unique reference number on the merchant interface and a preferred wallet application based on at least one predefined criteria may be facilitated for user selection to complete the payment transaction. The at least one predefined criteria relates to usage information of digital wallet applications. Some non-exhaustive example embodiments of completing the payment transactions using preferred wallet applications are described with reference to the following description, particularly with reference to FIGS. 2 to 5.

FIG. 2 represents a sequence flow diagram 200 representing a completion of a payment transaction using a unique virtual card number, in accordance with an example embodiment of the present disclosure. In an example embodiment, a user, upon accessing the e-commerce website and/or a mobile e-commerce application of the merchant accessible on his user device (e.g., the user device 102), is presented with one or more UIs displayed (not shown in FIG. 2) on a display screen of the user device 102 to select a payment method for current payment transaction. In at least one embodiment, the payment method includes a unique reference number based payment transaction. The unique reference number is a unique virtual card number in at least one example embodiment of the present disclosure. The format of the unique virtual card number may resemble to a digital token of the payment card or a primary account number (PAN) of the user.

At 205, the unique virtual card number and a transaction amount associated with current payment transaction is sent to the acquirer server 130 from the user device 102. The unique virtual card number and the transaction amount may be entered by the user on the UI of the e-commerce website by selecting the payment method of unique reference number based payment transaction using the user device 102. In an embodiment, the merchant server (not shown) receives the unique virtual card number and the transaction amount and forwards them to the acquirer server 130 for processing the payment transaction by creating a session ID. In an example embodiment, the transaction amount may be sent by the merchant through a merchant device to the merchant server and user may only be required to enter the unique virtual card number on the UI.

At 210, the acquirer server 130 sends the unique virtual card number and the transaction amount (along with the session ID) to the payment server 140. At 215, the payment server 140 accesses a mapping database to map the unique virtual card number (i.e., an example of the unique reference number) with the additional information stored therein. The mapping database includes wallet information of each wallet application of the user stored against the unique virtual card number. The payment server 140 is configured to update the mapping database on a predetermined periodic basis (e.g., every 90 minutes), or when such update is initiated by the customer.

The wallet information such as an identifier of the user device 102 (e.g., an International Mobile Equipment Identity (IMEI) number of the mobile phone), the platform ID of the user (e.g., email ID of the user or a wallet application ID of the user), a name of the wallet application (e.g., Google Pay™), a digital token generated by the wallet application for the payment card (e.g., xxxx xxxx xxxx 1234), a wallet application platform (e.g., Google®) and a current status (e.g., active) of the wallet application determined based on the type of the payment transaction and the at least one predefined criteria is stored and updated in the mapping database. In an embodiment, the wallet information is received by the payment server 140 from each wallet server through one or more public cloud platforms via upstream notifications.

At 220, the payment server 140 is configured to select a preferred wallet application from the plurality of wallet applications of the user. For example, the wallet application 104a of FIG. 1 may be selected by the payment server 140 based on at least on one predefined criteria and a type of the payment transaction. Examples of the type of payment transaction include person to merchant payment transaction and person to person payment transaction.

The predefined criteria may relate to usage information of each digital wallet application. For examples, predefined criteria can include how frequently a wallet application (e.g., Apple Pay® being used for all iTunes-store purchases) is being used by the user, purchase history of payment transactions made on various e-commerce websites (e.g., a bank wallet application being used for payments of electricity bills, Samsung Pay® being used for purchases from e-commerce website such as Amazon.com and the like), one or more rewards offered by each wallet application (e.g., bank wallet application offering 15% cashback, Microsoft wallet offering 500 reward points per purchase, and the like), network bandwidth utilization of each wallet application, battery usage of the user device per wallet application and the like. In an example embodiment, the most frequently used wallet application by the user may be considered as active wallet application and may be selected as a preferred wallet application for performing the payment transaction.

At 225, the payment server 140 notifies the wallet server of the preferred wallet application of the selection using the digital token generated by the wallet server for tokenizing the payment card of the user. For example, the wallet server 106a of the selected preferred wallet application 104a may be notified of the selection using the digital token extracted from the mapping database by the payment server 140. At 230, the wallet server 106a sends a request on the user device 102 to receive a user approval of the selection of the preferred wallet application 104a through one more UIs. The e-commerce website may redirect the user to another UI facilitated by the wallet server 106a for receiving the user approval. At 235, the user, using the UI on the user device 102, approves the selection of the preferred wallet application and the approval is sent to the payment server 140 over the payment network 145.

In at least one example embodiment, the user is given prime authority to disapprove the preferred wallet application 104a and provide his own preferences for using a different wallet application (e.g., the wallet application 104b of FIG. 1) than the one selected by the payment server 140. In such scenarios, the user may provide the user preferences using the UIs facilitated by the wallet server 106a. The wallet server 106a may forward the user disapproval and the user preferences to the payment server 140. The payment server 140 is configured to notify the wallet server 106b of the wallet application 104b selected by the user based on the user preferences and the payment transaction may be processed further using the user preferred wallet application 104b.

At 240, the payment server 140 is configured to extract the payment card information of the payment card using the unique virtual card number associated with the payment card. The payment card information may also be stored in the mapping database along with the other wallet information. The payment card information may include payment card number, expiry date, name of the cardholder, CVV number etc.

At 245, the payment server 140 sends the payment card information and the transaction amount to the issuer server 135 for authorization. Authorization of the payment card information is performed by the issuer server 135 (see, 250). The authorization process includes validating one or more of the payment card information of the payment card, verification of the cardholder identification, Mobile Personal Identification Number (MPIN), issuer account information and the like. Some non-exhaustive examples of the issuer account information include Bank Identifier Code (BIC), account number, payment card number and the like. Alternatively, the payment server 140 may notify the acquirer server 130 of the user approval using the session ID. In such a scenario, the acquirer server 130 sends the transaction amount and the payment card information to the issuer server 135 via the payment network 145 for authorization using the session ID.

At 255, the issuer server 135 notifies the payment server 140 (or the acquirer server 130) of the successful authorization of the payment card information, sufficient funds available for processing the transaction amount as well as verification of the cardholder.

At 260, the issuer server 135 debits the transaction amount from the account of the user. At 265, the issuer server 135 sends a notification of debiting of the transaction amount to the acquirer server 130 via the payment server 140. At 270, the acquirer server 130 credits the transaction amount in the merchant account. In an example embodiment, the acquirer server 130 may send the transaction status to the merchant interface. The transaction status may include successful, failure or pending. The acquirer server 130 may also send the transaction status to the user device 102. Alternatively, the transaction status may be sent by the merchant interface to the user device 102. The transaction process completes at operation 275.

Thus, a payment transaction completed using only a unique reference number (i.e., the unique virtual card number) provides a more secure payment method compared to entering payment card information on the e-portals every time while purchasing the items online. Further, the selection of the preferred wallet application and completing the payment transaction using the preferred wallet application frees the user from worrying about selecting the best wallet application for every digital payment transaction.

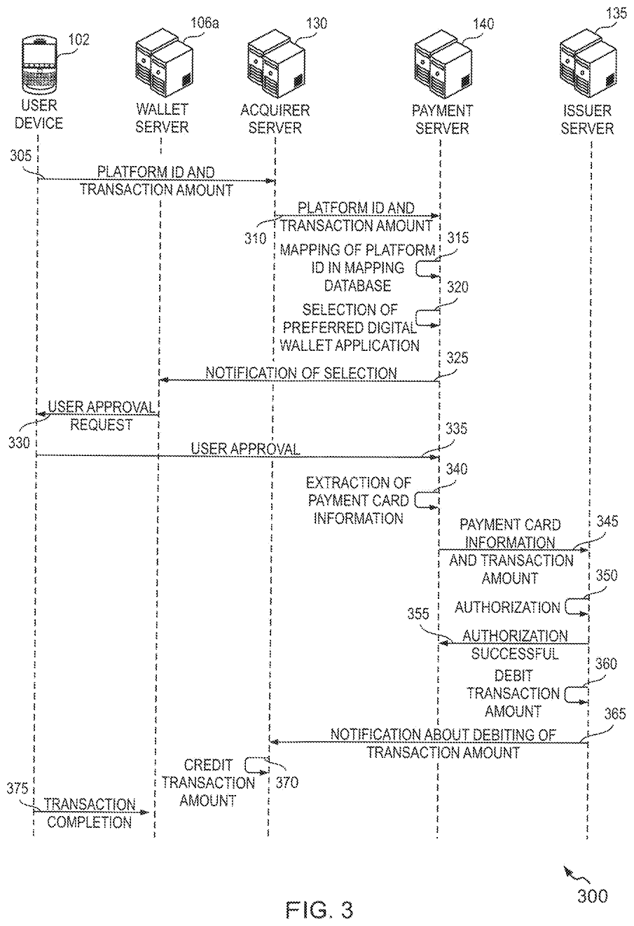

FIG. 3 represents a sequence flow diagram 300 representing a completion of a payment transaction using a platform ID, in accordance with another example embodiment of the present disclosure. The platform ID is another example of the unique reference number using which the user may be enabled to complete a payment transaction on a merchant interface. The merchant interface can be an online merchant interface such as a merchant website/e-commerce website, mobile or desktop applications, or third party websites or applications using which the consumer may purchase goods or service from a remote location or with in-store presence. The user may select a payment method related to the unique reference number payment transaction while making a payment transaction on the e-commerce website as explained with reference to FIG. 2.

At 305, the platform ID and a transaction amount (e.g., 1000 INR) associated with current payment transaction is sent to the acquirer server 130 from the user device 102. The examples of the platform ID include an email ID (e.g., john@gmail.com) or a wallet application ID (e.g., john@samsung.com for Samsung Pay® wallet application).

At 310, the acquirer server 130 sends the platform ID and the transaction amount to the payment server 140. The acquirer server 130 also determines the acquirer account of the merchant and sends the acquirer account details to the payment server 140.

At 315, the payment server 140 accesses a mapping database to map the platform ID (i.e., an example of the unique reference number) with the additional wallet information stored therein. The mapping database includes wallet information of each wallet application of the user stored against the platform ID. As explained with reference to FIG. 2, the payment server 140 is configured to update the mapping database on a predetermined periodic basis with the wallet information such as an identifier of the user device 102. Device identifiers are unique identifiers which can be used to identify the user device 102. Some non-exhaustive examples of the identifiers include, but not limited to, International Mobile Equipment Identity (IMEI), Mobile Equipment Identifier (MEID), Google ID, Apple ID, Samsung ID, mobile phone number, Media Access Control address (MAC address) and the like. Further, the payment server 140 identifies the merchant using the acquirer details received from the acquirer server 130 for facilitating completion of the payment transaction.

At 320, the payment server 140 is configured to select a preferred wallet application from the plurality of wallet applications of the user based on a predefined criteria and a type of the payment transaction. For example, a wallet application 104a utilizing the least battery consumption of the user device 102 may be selected as preferred wallet application. Alternatively, the user may select a wallet application 104c as a default preferred wallet application to be used for all the payment transactions irrespective of the rewards offered by all the other wallet applications 104a-n. This may be provided as a user preference by the user.

At 325, the payment server 140 notifies the wallet server 106a of the preferred wallet application 104a of the selection using the digital token. At 330, the wallet server 106a sends a request on the user device 102 to receive a user approval of the selection of the preferred wallet application 104a through one more UIs. At 335, the user approves the selection of the preferred wallet application 104a and the approval is sent to the payment server 140 over the payment network 145.

At 340, the payment server 140 is configured to extract the payment card information of the payment card using the platform ID. At 345, the payment server 140 sends the payment card information and the transaction amount to the issuer server 135 for authorization. Authorization of the payment card information is performed by the issuer server 135 (see, 350). At 355, the issuer server 135 notifies the payment server 140 of the successful authorization of the payment card information, sufficient funds available for processing the transaction amount and verification of the cardholder.

At 360, the issuer server 135 debits the transaction amount from the account of the user. At 365, the issuer server 135 sends a notification of debiting of the transaction amount to the acquirer server 130 via the payment network 145. At 370, the acquirer server 130 credits the transaction amount in the merchant account. The transaction process completes at operation 375 using the platform ID as unique reference number for performing the payment transaction. Such a payment transaction flow as explained with reference to FIG. 3 provides the end consumers a better user experience as compared to conventional techniques. Since, only the platform ID (or the unique virtual card number of FIG. 2) flows through the various channels, it prevents misuse of the payment card information. Further, the user is no longer required to enter his payment card information separately on each e-commerce website. Additionally, the user does not need to worry if a wallet application is uninstalled from one user device and is installed in another user device as the wallet synchronization of each wallet application of the user with the payment server 140 occurs in real time on a predetermined periodic basis via the network 150.

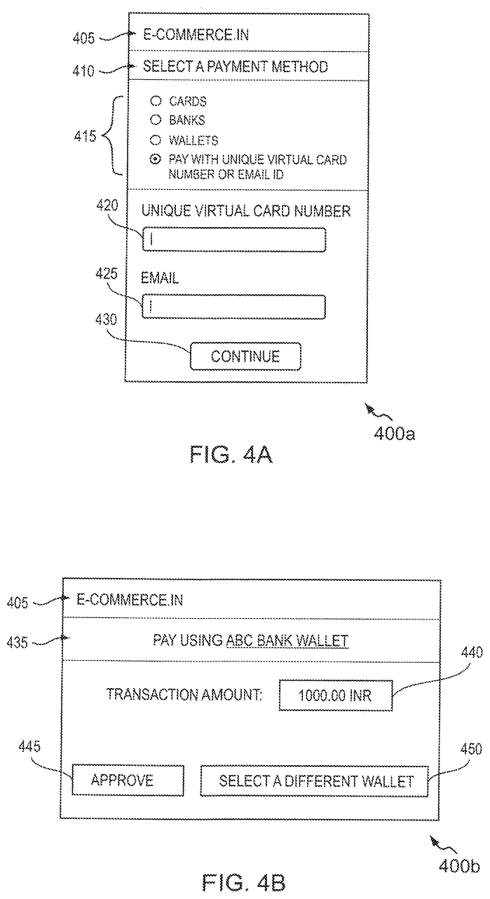

FIG. 4A is a simplified schematic representation of an example User Interface (UI) 400a of an e-commerce website 405 (e.g., e-commerce.in) configured to display a payment method related to unique reference number based payment transaction on a user device, in accordance with an example embodiment of the present disclosure. A header 410 displaying text ‘select a payment method’ is accompanied by a plurality of payment methods 415 (hereinafter alternatively referred to as payment methods 415) exemplarily displayed as ‘cards’, ‘banks’, ‘wallets’ and ‘pay with unique virtual card number or email ID’. The user is enabled to select any of the payment methods 415 based on his preferences. The UI 400a displays a user selection of the payment method ‘pay with unique virtual card number or email ID’. In an alternate embodiment, the user may first select ‘wallets’ as a preferred payment method and then may be directed to a UI using which the unique virtual card number or the platform Id may be entered. The user may enter a unique virtual card number (such as yyyy yyyy yyyy yyyy, not shown) in a form field 420 and click a button 430 (see, continue) to submit the unique virtual card number. Alternatively, the user enters an email ID such as John@gmail.com (not shown) using a form field 425 and clicks the button 430 labeled as ‘Continue’. Email ID is an example of the platform ID of the user using which the payment transaction is facilitated.

As explained with reference to FIGS. 2 and 3, the merchant server sends the unique reference number to the payment server 140 via the acquirer server 130. The payment server 140 accesses the mapping database to extract the plurality of wallet applications for selecting preferred wallet application using the unique reference number. The selection of the preferred wallet application is done based on current status of each wallet application determined based on the predefined criteria. In an example embodiment, the wallet application that is marked ‘active’ in the mapping database may be selected as preferred wallet application for performing the payment transaction. This is explained in detail with reference to FIG. 4B.

FIG. 4B is a simplified schematic representation of an example User Interface (UI) 400b of the e-commerce website 405 (e.g., e-commerce.in 405) configured to display a preferred digital wallet application for making a payment transaction on a user device, in accordance with an example embodiment of the present disclosure. The UI 400b displays an information field 435 with text ‘pay using ABC Bank wallet’. Thus, a wallet application named ABC Bank wallet is selected as a preferred wallet application by the payment server 140 for the unique reference number entered by the user using the form field 420 of the UI 400a. The payment server 140 notifies the wallet server of the ABC Bank using the digital token generated by the ABC Bank for the payment card of the user. The UI 400b may therefore be facilitated by the wallet server of the ABC Bank. Alternatively, the UI 400b may be facilitated by the merchant server.

The UI 400b further displays transaction amount (exemplarily depicted as 1000.00 INR) using an information field 440. The user is enabled to approve the selected preferred wallet application i.e., the ‘ABC Bank wallet’ by clicking a button 445 labeled ‘Approve’. The user approval is sent to the payment server 140 for completing the payment transaction using the ABC Bank wallet application. Thereafter, operations 240 to 275 as explained with reference to FIG. 2 are performed by various server systems to complete the payment transaction. For example, the payment server 140 sends the payment card information retrieved from the mapping database to the issuer server 135 for authorization. The issuer server 135 verifies whether the user's payment account (i.e. the issuer account) is in good standing and whether the prospective purchase is covered by the user's available credit line or account balance. If the account holds enough balance amount, the issuer server 135 debits the exact number of transaction amount from the account and notifies the payment server 140 and/or the acquirer server 130 of successful authorization. The payment transaction completes with security against theft and simplicity using card-less transactions by crediting the transaction amount by the acquirer server 130 into the merchant account.

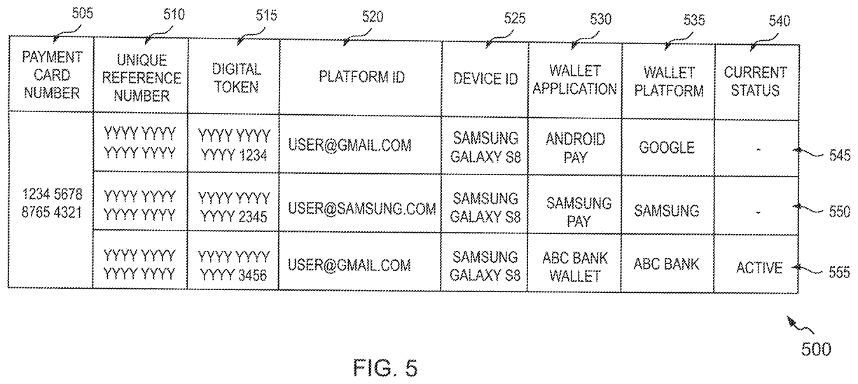

Alternatively, the user may click a button 450 labeled ‘select a different wallet’ to disapprove the ABC Bank wallet and select another wallet of his preferences. In such a scenario, the user may be directed to a new UI (not shown) listed with a plurality of wallet applications of the user for user selection. Using such a UI, the user may also be enabled to provide other user preferences that may be saved against each wallet application in the mapping database by the payment server 140. The exemplary mapping database is explained hereinafter in detail with reference to FIG. 5.

In another example embodiment, an existing POS terminal present at the merchant facility may be upgraded to facilitate unique reference number based payment transactions using preferred wallet applications. To achieve this, the POS terminal may be provided with an operating system and various software applications that can provide various functionalities to the POS terminal. For example, in some embodiments, the POS terminal may be addressable with an Internet protocol and may include a browser application. In such embodiments, the POS terminal includes software adapted to support such functionality. In some embodiments, the POS terminal executes software to support network management. In particular, this capacity allows software to be downloaded to a plurality of such systems to provide new applications such as application for enabling unique reference number based payment transactions using POS terminals and/or updates to existing applications. The operating system and software application upgrades may be distributed and maintained through communication to the POS terminal over a communication network, such as the network 150 of FIG. 1.

FIG. 5 is a simplified schematic representation of a mapping database 500 configured to store wallet information of a plurality of digital wallet applications of a user, in accordance with an example embodiment of the present disclosure. As shown, the mapping database 500 includes a listing of plurality of wallet information associated with each wallet application as represented by rows 545, 550 and 555 and the columns 505, 510, 515, 520, 525, 530, 535 and 540. For example, columns include, a payment card number 505, a unique reference number 510, a digital token 515, a platform ID 520, a device ID 525, a wallet application (name) 530, a wallet platform 535, and a current status 540 of each wallet application. Further, a row 545 represents that for the payment card number ‘1234 5678 8765 4321’, the unique reference number is ‘yyyy yyyy yyyy yyyy’, the digital token is ‘yyyy yyyy yyyy 1234’, the platform ID is ‘user@gmail.com’, the device ID is ‘Samsung galaxy S8’, the wallet application is ‘Google pay’, the wallet platform is ‘Google’ and the current status is ‘-’ (i.e., inactive). Likewise each row represents wallet information of each wallet application of the user. For example, based on the wallet information of the row 555, the wallet application ‘ABC Bank wallet’ may be selected by the payment server 140 as a preferred wallet application as the current status of the ‘ABC Bank wallet’ is marked ‘active’ in the mapping database 500.

In an example embodiment, a selection of the preferred wallet for a transaction may be determined based on providing weightage to various criteria. For instance, the battery consumed when particular wallet is used has a weightage w1, the network usage by the wallet has a weightage w2, cashback or similar offers or discounts scheme has a weightage w3, a historical usage of wallet has a weightage w4, etc. A score based on the all the criteria with corresponding weightage is calculated for all the wallets, and the preferred wallet may be determined as one having the highest score.

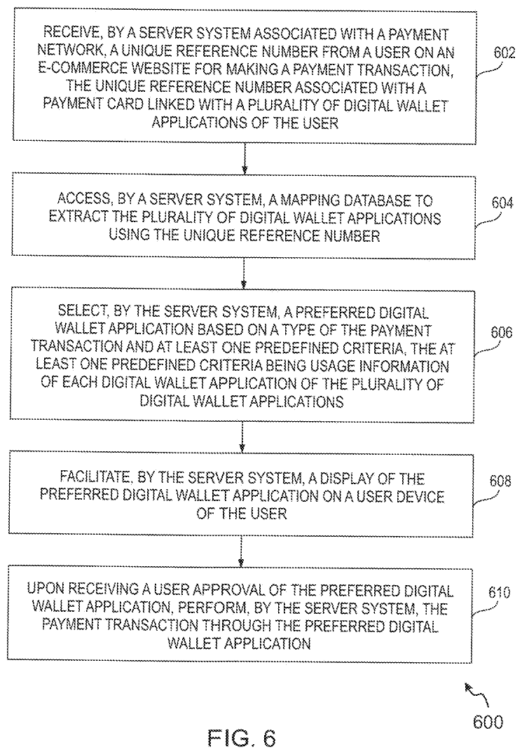

FIG. 6 illustrates a flow diagram of a method 600 for facilitating payment transaction using a preferred digital wallet application, in accordance with an example embodiment of the present disclosure. More specifically, the method 600 for enabling usage of a unique reference number associated with a payment card of a user for making a payment transaction on an e-commerce website of the merchant is disclosed. The method 600 depicted in the flow diagram may be executed by, for example, the at least one server system such as the wallet servers 106a-n, the acquirer server 130, the issuer server 135, and the payment server 140 explained with reference to FIG. 1. Operations of the flow diagram 600, and combinations of operation in the flow diagram 600, may be implemented by, for example, hardware, firmware, a processor, circuitry and/or a different device associated with the execution of software that includes one or more computer program instructions. The operations of the method 600 are described herein with help of the server systems 106a-n, 130, 135, or 140. It is noted that the operations of the method 600 can be described and/or practiced by using a system other than these server systems. The method 600 starts at operation 602.

At 602, the method 600 includes receiving, by a server system (e.g., a merchant server) associated with a payment network, a unique reference number from a user on an e-commerce website for making a payment transaction. The unique reference number is associated with a payment card linked with a plurality of wallet applications of the user. These plurality of wallet applications may not be necessarily installed or available on one user device, and these may be installed or available on multiple user devices, or may be accessed by the user on the need basis from sources such as web portals, web links and the like associated with wallet applications. In an embodiment, the unique reference number is any one of a unique virtual card number or a platform ID of the user. The merchant server sends the unique reference number to the payment server 140 via the acquirer server 130 for processing the payment transaction.

At 604, the method 600 includes, accessing, by the server system (e.g., the payment server 140), a mapping database (e.g., the mapping database 500 of FIG. 5) to extract the plurality of wallet applications using the unique reference number.

At 606, the method 600 includes selecting, by the server system (e.g., the payment server 140), a preferred wallet application based on a type of the payment transaction and at least one predefined criteria. The at least one predefined criteria may be a usage information of each wallet application of the plurality of digital wallet applications.

At 608, the method 600 includes facilitating, by the server system (e.g., the wallet server of the preferred wallet application or the merchant server), a display of the preferred wallet application on a user device of the user. Herein, facilitating the display of preferred wallet application includes sending a notification of the preferred wallet application to the user device directly or through other intermediary servers associated with the payment network. As explained with reference to FIG. 4B, the user may be enabled to disapprove the displayed preferred wallet application and provide his own preferences for reselecting a preferred wallet application to complete the payment transaction.

Upon receiving a user approval of the preferred wallet application, at 610, the method 600 includes performing, by the server system, the payment transaction through the preferred digital wallet application. In an embodiment, the payment server 140 is configured to send payment card information of the payment card of the user to the issuer server 135 for authorization. Upon receiving successful authorization, the payment server 140 is configured to complete the payment transaction. It should be appreciated that the operations 602-610 are performed without the need of the user to share the payment card information of his payment card on the e-commerce web site to carry out the payment transaction. Since the user is only required to enter the unique reference number on the merchant interface, and the server system is required to select a preferred wallet application using the unique reference number, the overall time and steps needed to complete the payment transaction reduces adequately. Such arrangement further leads to more secure payment transactions and better user experiences.

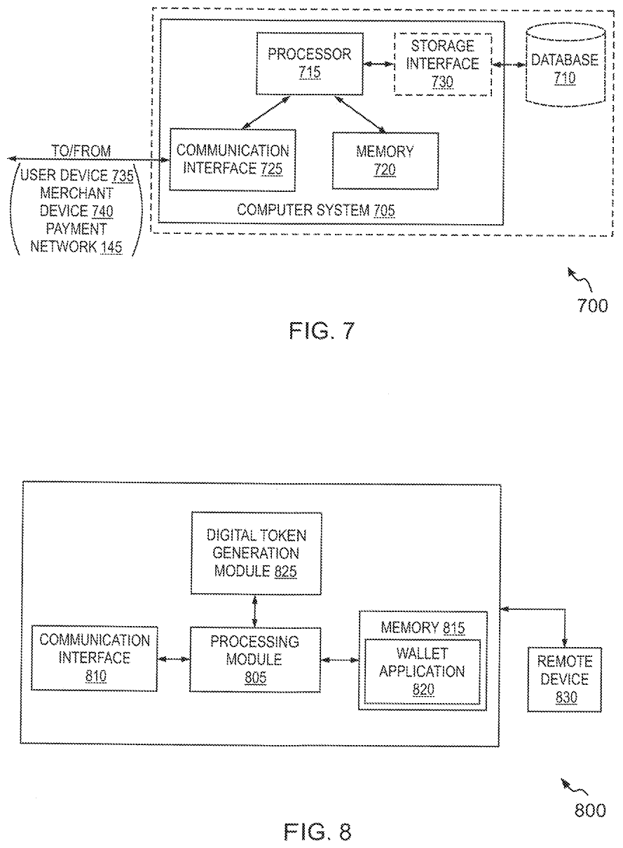

FIG. 7 is a simplified block diagram of a server system 700 configured to facilitate payment transaction using a preferred digital wallet application, in accordance with one embodiment of the present disclosure. The server system 700 is an example of a server system that is a part of the payment network 145. Examples of the server system 700 includes, but not limited to, the acquirer server 130, the issuer server 135, the wallet servers 106a-n, and the payment server 140. The server system 700 includes a computer system 705 and a database 710.

The computer system 705 includes at least one processor 715 for executing instructions. Instructions may be stored in, for example, but not limited to, a memory 720. The processor 715 may include one or more processing units (e.g., in a multi-core configuration).

The processor 715 is operatively coupled to a communication interface 725 such that the computer system 705 is capable of communicating with a remote device such as a merchant device 740 (e.g., the POS terminal or any other the merchant interface such as an e-commerce website) or a user device 735 (e.g., the user device 102) or communicating with any entity within the payment network 145. For example, the communication interface 725 may receive the unique reference number from the user device 735 (i.e., the user device 102), via the Internet.

The processor 715 may also be operatively coupled to the database 710. The database 710 is any computer-operated hardware suitable for storing and/or retrieving data, such as, but not limited to, transaction data generated as part of sales activities conducted over the bankcard network including data relating to merchants, account holders or customers, and purchases. The database 710 may also store information related to a plurality of user's payment accounts. Each user account data includes at least one of a user name, a user address, an account number, PIN, and other account identifiers. The database 710 may also store device identifiers, platform IDs of the users and the digital tokens. The database 710 may also store a merchant identifier that identifies each merchant registered to use the payment network, and instructions for settling transactions including merchant bank account information (e.g., a plurality of payment accounts related to the merchant interfaces associated with merchants). The database 710 may further include issuer account information. The database 710 may include multiple storage units such as hard disks and/or solid-state disks in a redundant array of inexpensive disks (RAID) configuration. The database 710 may include a storage area network (SAN) and/or a network attached storage (NAS) system.

In some embodiments, the database 710 is integrated within the computer system 705. For example, the computer system 705 may include one or more hard disk drives as the database 710. In other embodiments, the database 710 is external to the computer system 705 and may be accessed by the computer system 705 using a storage interface 730. The storage interface 730 is any component capable of providing the processor 715 with access to the database 710. The storage interface 730 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 715 with access to the database 710.

The processor 715 is configured to generate a unique reference number to be associated with a payment card of the user and is capable of being retrieved from the database 710 when received via the communication interface 725 during a payment transaction to select a preferred wallet application linked with the payment card of the user. The authorization of the payment card information may also be performed by the processor 715 by validating the payment card information of the payment card using the associated card information stored in the database 710. The processor 715 is further configured to approve the transaction amount by verifying against the available balance in the issuer account of the user, as stored in the database 710. The processor 715 is configured to display the selected preferred wallet application on the user device 735 using the digital token retrieved from the database 710 via the communication interface 725 for facilitating completion of the payment transaction. The processor 715 is also configured to receive one or more user preferences for selecting the preferred wallet application via the communication interface 725. In an embodiment, the processor 715 may be configured to notify the user device 735 and the merchant device 740 of the transaction status via the communication interface 725.

FIG. 8 is a simplified block diagram of a digital wallet server 800 (hereinafter referred to as wallet server 800) used for payment transaction using a preferred digital wallet application, in accordance with one embodiment of the present disclosure. The wallet server 800 is an example of the any of the wallet servers 106a-n of FIG. 1. The wallet server 800 facilitates mobile banking applications, bank wallet applications, third-party wallet applications, payment gateways and the like to provide its registered users storage of their payment cards on digital platform so as to make card-less payments. The wallet server 800 includes at least one processing module 805 communicably coupled to a communication interface 810, at least one memory 815 and a digital token generation module 825. In at least one embodiment, the wallet server 800 may be accessible to remote devices, such as a remote device 830, through a communication network, such as the network 150 or the payment network 145.

The processing module 805 is capable of executing the stored machine executable instructions of a wallet application 820 (e.g., any of the wallet applications 104a-n of FIG. 1) in the memory 815 or within the processing module 805 or any storage location accessible to the processing module 805. The processing module 805 is configured to perform the various operations as explained with reference to method 600. For example, the processing module 805 is configured to receive the tokenization request from a user device of a user via the communication interface 810 for the tokenization of the payment card. The processing module 805 is configured to store the card information of the payment card for facilitating the user to make digital payment transactions using the stored card information. The processing module 805, in conjunction with, the digital token generation module 825 is configured to generate a digital token to be associated with the payment card. The digital token generation module 825 is configured to include various cryptographic algorithms that can be used by the processing module 805 to generate the cryptograms to be associated with the generated digital tokens for enhanced security of digital payments.

In an embodiment, the processing module 805 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like

In an embodiment, the wallet server 800 may include an input/output module (I/O module) (not shown) configured to receive inputs from (e.g., one or more user preferences) and provide outputs (e.g., display a preferred wallet application based on the one or more user preferences) to the end-user (i.e. the merchant and/or the users) of the wallet application 820. For instance, the I/O module may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a speaker, a ringer, a vibrator, and the like.

The memory 815 can be any type of storage accessible to the processing module 805. The memory 815 includes program instructions for facilitating the wallet application 820. For example, the memory 815 may include volatile or non-volatile memories, or a combination thereof. In some non-limiting examples, the memory 815 can be four to sixty-four Megabytes (MB) of Dynamic Random Access Memory (“DRAM”) or Static Random Access Memory (“SRAM”). In addition, some examples may include supplementary flash memory installed via a PCMCIA slot.

The communication interface 810 is further configured to cause display of user interfaces on the remote device 830 (e.g., the user device 735 or the user device 102). In one embodiment, the communication interface 810 includes a transceiver for wirelessly communicating information to, or receiving information from, the remote device 830 or other suitable display device, and/or another type of remote processing device. In another embodiment, the communication interface 810 is capable of facilitating operative communication with the remote devices and a cloud server using Application Program Interface (API) calls. The communication may be achieved over a communication network, such as the network 150.

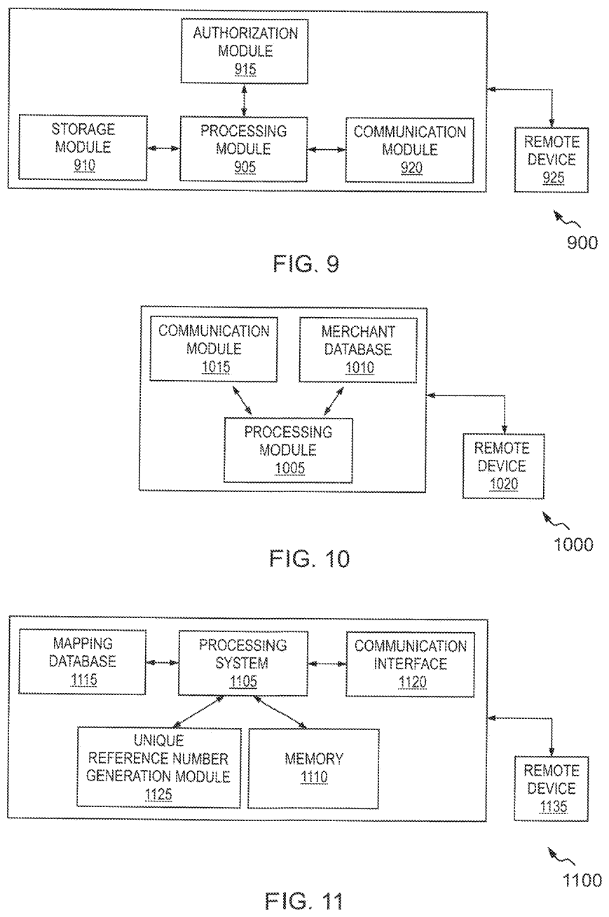

FIG. 9 is a simplified block diagram of an issuer server 900 used for payment transaction using a preferred digital wallet application, in accordance with one embodiment of the present disclosure. The issuer server 900 is an example of the issuer server 135 of FIG. 1, or may be embodied in the issuer server 135. The issuer server 900 is associated with an issuer bank/issuer, in which a user may have an account. The issuer server 900 includes a processing module 905 operatively coupled to a storage module 910, an authorization module 915, and a communication module 920. The components of the issuer server 900 provided herein may not be exhaustive, and that the issuer server 900 may include more or fewer components than that of depicted in FIG. 9. Further, two or more components may be embodied in one single component, and/or one component may be configured using multiple sub-components to achieve the desired functionalities. Some components of the issuer server 900 may be configured using hardware elements, software elements, firmware elements and/or a combination thereof.

The storage module 910 is configured to store machine executable instructions to be accessed by the processing module 905. Additionally, the storage module 910 stores information related to, contact information of the user, identification information of the user, bank account number, BICs, payment card details, internet banking information, PIN, mobile personal identification number (MPIN) for mobile banking and the like. The PIN is a four-digit identification code issued by the issuer bank of the user while registering for electronic payment transactions or while issuing the payment card to the user. For example, the PIN may be issued for swipe based transactions, mobile banking, internet banking, and the like. The PIN is needed to be verified for authentication of the user's identity and association with the issuer bank to process the payment transaction. This information is retrieved by the processing module 905 for cross-verification during payment transactions.

The processing module 905, in conjunction with the authorization module 915, is configured to validate the payment card information received from the payment server 140 via the communication module 920. Additionally, the processing module 905 is configured to verify the PIN (e.g., whether the four-digit numeric code matches the PIN issued by the issuer), the sufficient funds in the issuer account and the like. Upon successful authorization of the payment card information and the cardholder only, the payment transaction is processed further by the processing module 905 by debiting the transaction amount from the issuer account of the user. The processing module 905 is further configured to communicate with one or more remote devices such as a remote device 925 using the communication module 920 over a network such as the network 150 or the payment network 145 of FIG. 1. The examples of the remote device 925 include, the merchant device 740, the user device 735, the payment server 140, the acquirer server 130, the wallet server 800, other computing systems of issuer and the payment network 145 and the like. The communication module 920 is capable of facilitating such operative communication with the remote devices and cloud servers using API (Application Program Interface) calls. In an embodiment, the processing module 905 may be configured to store program instructions for facilitating banking wallet application to the registered users of the issuer bank. In such scenarios, the processing module 905 may further include a digital token generation module (not shown) to generate the digital token to be associated with the payment card of the user for facilitating digital payment transactions through the banking wallet application.

FIG. 10 is a simplified block diagram of an acquirer server 1000 used for payment transaction using a preferred digital wallet application, in accordance with one embodiment of the present disclosure. The acquirer server 1000 is associated with the acquirer bank of a merchant where the merchant has established an account to accept payment performed using the unique reference number. The acquirer server 1000 is an example of the acquirer server 130 of FIG. 1, or may be embodied in the acquirer server 130. Further, the acquirer server 1000 is configured to facilitate the unique reference number based payment transaction with the issuer server 900 using the payment network 145 of FIG. 1. The acquirer server 1000 includes a processing module 1005 communicably coupled to a merchant database 1010 and a communication module 1015. The components of the acquirer server 1000 provided herein may not be exhaustive, and that the acquirer server 1000 may include more or fewer components than that of depicted in FIG. 10. Further, two or more components may be embodied in one single component, and/or one component may be configured using multiple sub-components to achieve the desired functionalities. Some components of the acquirer server 1000 may be configured using hardware elements, software elements, firmware elements and/or a combination thereof.

The merchant database 1010 includes data related to merchant, such as, but not limited to, a merchant primary account number (PAN), a merchant name, a merchant category code (MCC), a merchant city, a merchant postal code, a merchant brand name, a merchant ID and the like. The processing module 1005 is configured to use the merchant ID to identify the merchant during the normal processing of payment transactions, adjustments, chargebacks, end-of-month fees and so forth. The merchant ID is different than other merchant account numbers, particularly those that identify merchants to the equipment (e.g., the POS terminals or any other merchant electronic devices/interfaces) they use for processing transactions. A merchant with a single merchant processing account number may use several terminals at one location, resulting in one merchant ID and several terminal identification numbers (TIDs). The processing module 1005 may be configured to store and update such merchant information in the merchant database 1010 for later retrieval.

In an embodiment, the communication module 1015 is capable of facilitating operative communication with a remote device 1020 (e.g., the issuer server 900, the merchant device 740, the wallet server 800 and/or the payment server 140) using API calls. The communication may be achieved over a communication network, such as the network 150. For example, the processing module 1005 may receive the unique reference number and the transaction amount from the merchant device 740/merchant server using the communication module 1015. Further, the processing module 1005 is configured to receive the debited transaction amount from the payment server 140 or the issuer server 135 (or the issuer server 900) using the communication module 1015. Thereafter, the processing module 1005 may retrieve merchant PAN from the merchant database 1010 to credit the transaction amount in the acquirer account of the merchant. Further, in an example embodiment, the processing module 1005 may be configured to send the transaction status to the merchant device 740 of the merchant and the user device 735.

FIG. 11 is a simplified block diagram of a payment server 1100 used for payment transaction using a preferred digital wallet application, in accordance with one embodiment of the present disclosure. The payment server 1100 may correspond to the payment server 140 of FIG. 1. As explained with reference to FIG. 1, the payment server 140 is associated with the payment network 145. The payment network 145 may be used by the wallet server 800, the issuer server 900 and the acquirer server 1000 as a payment interchange network. Examples of the payment interchange network include, but not limited to, Mastercard® payment system interchange network. The payment server 1100 includes a processing system 1105 configured to extract programming instructions from a memory 1110 to provide various features of the present disclosure. The components of the payment server 1100 provided herein may not be exhaustive, and that the payment server 1100 may include more or fewer components than that of depicted in FIG. 11. Further, two or more components may be embodied in one single component, and/or one component may be configured using multiple sub-components to achieve the desired functionalities. Some components of the payment server 1100 may be configured using hardware elements, software elements, firmware elements and/or a combination thereof.

Via a communication interface 1120, the processing system 1105 receives a unique reference number from a remote device 1135 such as the user device 102 (or the user device 735) of FIG. 1 for making a payment transaction. The communication may be achieved through API calls, without loss of generality. The processing system 1105 is configured to select a preferred wallet application based on a predefined criteria from a mapping database 1115 and facilitate display of the preferred wallet application on the user device 102 via the communication interface 1120.

A unique reference number generation module 1125, operatively coupled to the processing system 1105, is configured to generate the unique reference number to be associated with the payment card of the user. The unique reference number values vary in format and may be cryptographically or non-cryptographically generated. For example, the cryptogram/the dynamic data may be generated using EMV®-based cryptography to secure the payment transaction i.e., in place of an account PAN of the user, the cryptogram may be accompanied by a 16-digit reference number (e.g., unique virtual card number) such that the use of such a number rather than a PAN minimizes the impact of account data compromise. The generated unique reference numbers and the original PANs or the payment card numbers they map to are stored securely in the mapping database 1115 of the payment server 1100 and the mapping is used during the de-tokenization process i.e. during a payment transaction to select a preferred wallet application.

The processing system 1105 is further configured to continually manage the unique reference numbers through suspension, deletions, updates, etc. The processing system 1105 may be configured to perform various functions such as maintenance and operation of the mapping database 1115 based on a predefined criteria and at a predetermined periodic basis, unique reference number issuance and provisioning, unique reference number domain restriction controls (e.g., the unique reference number may be used at a Point of Sale transaction and also in another transaction at an e-commerce website) and the like. The mapping database 1115 may also store the other wallet information of the plurality wallet applications linked with the payment card of the user as explained with reference to FIG. 5. Additionally, payment card information of the payment card, PIN, the transaction amount, acquirer account information, transaction records, merchant account information, and the like may also be stored in the mapping database 1115.

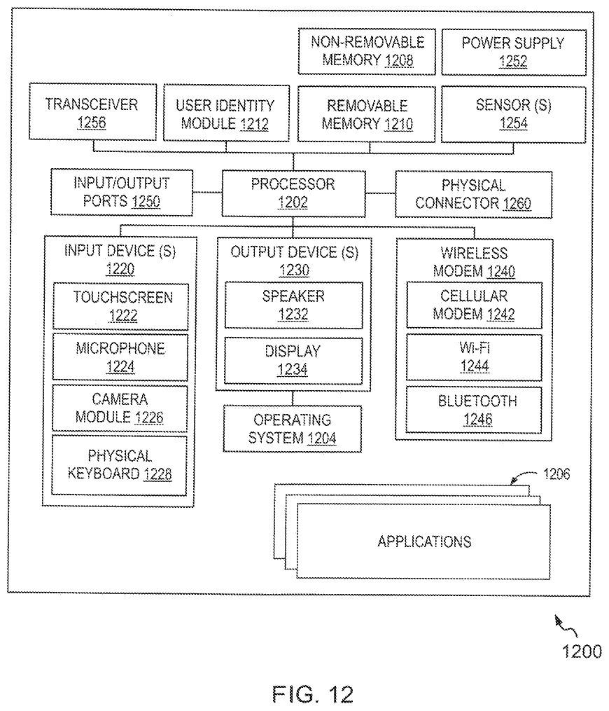

FIG. 12 shows simplified block diagram of a user device 1200 for example a mobile phone or a desktop computer capable of implementing the various embodiments of the present disclosure. For example, the user device 1200 may correspond to the user device 735 (e.g., the user device 102 of FIG. 1) of FIG. 7. The user device 1200 is depicted to include one or more applications 1206.

It should be understood that the user device 1200 as illustrated and hereinafter described is merely illustrative of one type of device and should not be taken to limit the scope of the embodiments. As such, it should be appreciated that at least some of the components described below in connection with that the user device 1200 may be optional and thus in an example embodiment may include more, less or different components than those described in connection with the example embodiment of the FIG. 12. As such, among other examples, the user device 1200 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 1200 includes a controller or a processor 1202 (e.g., a signal processor, microprocessor, ASIC, or other control and processing logic circuitry) for performing such tasks as signal coding, data processing, image processing, input/output processing, power control, and/or other functions. An operating system 1204 controls the allocation and usage of the components of the user device 1200 and support for one or more payment transaction applications programs (see, the applications 1206) such as the wallet applications 104a-n of FIG. 1, that implements one or more of the innovative features described herein. The wallet applications can be an instance of an application downloaded from any of the wallet servers 106a-n of FIG. 1. The wallet applications are capable of communicating with any of the servers 130, 135, 106a-n and 140 and the merchant interface for facilitating the payment transactions using the unique reference number. In addition to the wallet applications, the applications 1206 may include common mobile computing applications (e.g., telephony applications, email applications, calendars, contact managers, web browsers, messaging applications) or any other computing application.

The illustrated user device 1200 includes one or more memory components, for example, a non-removable memory 1208 and/or removable memory 1210. The non-removable memory 1208 and/or the removable memory 1210 may be collectively known as a database in an embodiment. The non-removable memory 1208 can include RAM, ROM, flash memory, a hard disk, or other well-known memory storage technologies. The removable memory 1210 can include flash memory, smart cards, or a Subscriber Identity Module (SIM). The one or more memory components can be used for storing data and/or code for running the operating system 1204 and the applications 1206. The user device 1200 may further include a user identity module (UIM) 1212. The UIM 1212 may be a memory device having a processor built in. The UIM 1212 may include, for example, a subscriber identity module (SIM), a universal integrated circuit card (UICC), a universal subscriber identity module (USIM), a removable user identity module (R-UIM), or any other smart card. The UIM 1212 typically stores information elements related to a mobile subscriber. The UIM 1212 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 1200 can support one or more input devices 1220 and one or more output devices 1230. Examples of the input devices 1220 may include, but are not limited to, a touch screen/a display screen 1222 (e.g., capable of capturing finger tap inputs, finger gesture inputs, multi-finger tap inputs, multi-finger gesture inputs, or keystroke inputs from a virtual keyboard or keypad), a microphone 1224 (e.g., capable of capturing voice input), a camera module 1226 (e.g., capable of capturing still picture images and/or video images) and a physical keyboard 1228. Examples of the output devices 1230 may include, but are not limited to a speaker 1232 and a display 1234. Other possible output devices can include piezoelectric or other haptic output devices. Some devices can serve more than one input/output function. For example, the touch screen 1222 and the display 1234 can be combined into a single input/output device.

A wireless modem 1240 can be coupled to one or more antennas (not shown in the FIG. 12) and can support two-way communications between the processor 1202 and external devices, as is well understood in the art. The wireless modem 1240 is shown generically and can include, for example, a cellular modem 1242 for communicating at long range with the mobile communication network, a Wi-Fi compatible modem 1244 for communicating at short range with an external Bluetooth-equipped device or a local wireless data network or router, and/or a Bluetooth-compatible modem 1246. The wireless modem 1240 is typically configured for communication with one or more cellular networks, such as a GSM network for data and voice communications within a single cellular network, between cellular networks, or between the user device 1200 and a public switched telephone network (PSTN).

The user device 1200 can further include one or more input/output ports 1250, a power supply 1252, one or more sensors 1254 for example, an accelerometer, a gyroscope, a compass, or an infrared proximity sensor for detecting the orientation or motion of the user device 1200 and biometric sensors for scanning biometric identity of an authorized user, a transceiver 1256 (for wirelessly transmitting analog or digital signals) and/or a physical connector 1260, which can be a USB port, IEEE 1294 (FireWire) port, and/or RS-232 port. The illustrated components are not required or all-inclusive, as any of the components shown can be deleted and other components can be added.

The disclosed method with reference to FIG. 6, or one or more operations of the flow diagram 600 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server systems 130, 135, 106a-n and 140 its various components such as the computer system 705 and the database 710 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
receiving, by a server system associated with a payment network, a unique reference number from a user on an e-commerce website for making a payment transaction, the unique reference number associated with a payment card linked with a plurality of digital wallet applications of the user;
accessing, by the server system, a mapping database to extract the plurality of digital wallet applications using the unique reference number;
selecting, by the server system, a preferred digital wallet application based on a type of the payment transaction and at least one predefined criteria, the at least one predefined criteria being usage information of each digital wallet application of the plurality of digital wallet applications;
facilitating, by the server system, a display of the preferred digital wallet application on a user device of the user; and
upon receiving a user approval of the preferred digital wallet application, performing, by the server system, the payment transaction through the preferred digital wallet application.

2. The method as claimed in claim 1, wherein the unique reference number is at least one of a unique virtual card number and a platform ID of the user.

3. The method as claimed in claim 2, wherein the server system is a payment server and wherein the method further comprises:
updating the mapping database with a wallet information of each digital wallet application of the plurality of digital wallet applications against the unique reference number.

4. The method as claimed in claim 3, wherein the wallet information of each digital wallet application comprises an identifier of the user device, the platform ID of the user, a name of a digital wallet application, a digital token generated by the digital wallet application for the payment card, a digital wallet application platform and a current status of the digital wallet application determined based on the type of the payment transaction and the at least one predefined criteria.

5. The method as claimed in claim 4, wherein the server system is a payment server and wherein the method further comprises:
notifying a digital wallet server of the preferred digital wallet application using the digital token.

6. The method as claimed in claim 2, further comprising:
receiving one or more user preferences from the user device of the preferred digital wallet application to be used for making the payment transaction; and
facilitating the display of the preferred digital wallet application on the user device based on the one or more user preferences.

7. The method as claimed in claim 2, wherein the server system is a payment server and wherein the method further comprises:
receiving a transaction amount along with the unique reference number from an acquirer server.

8. The method as claimed in claim 2, wherein the server system is a payment server and wherein the method further comprises:
extracting a payment card information of the payment card associated with the unique reference number;
sending the payment card information to an issuer server for authorization; and
upon successful authorization of the payment card information, performing the payment transaction.

9. The method as claimed in claim 1, wherein the at least one predefined criteria is any one of a purchase history, one or more rewards offered by each digital wallet application, a network bandwidth utilization, and a battery usage of the user device.

10. A server system in a payment network, the server system comprising:
a communication interface for receiving a unique reference number from a user on an e-commerce website for making a payment transaction, the unique reference number associated with a payment card linked with a plurality of digital wallet applications of the user;
a memory comprising executable instructions; and
a processor communicably coupled to the communication interface and configured to execute the instructions to cause the server system to at least:
access a mapping database to extract the plurality of digital wallet applications using the unique reference number;
select a preferred digital wallet application based on a type of the payment transaction and at least one predefined criteria, the at least one predefined criteria being usage information of each digital wallet application of the plurality of digital wallet applications;
facilitate a display of the preferred digital wallet application on a user device of the user; and
upon receiving a user approval of the preferred digital wallet application, perform the payment transaction through the preferred digital wallet application.

11. The server system as claimed in claim 10, wherein the unique reference number is at least one of a unique virtual card number and a platform ID of the user.

12. The server system as claimed in claim 11, wherein the server system is a payment server and wherein the server system is caused to:
update the mapping database with a wallet information of each digital wallet application of the plurality of digital wallet applications against the unique reference number.

13. The server system as claimed in claim 12, wherein the wallet information of each digital wallet application further comprises an identifier of the user device, the platform ID of the user, a name of a digital wallet application, a digital token generated by the digital wallet application for the payment card, a digital wallet application platform and a current status of the digital wallet application determined based on the type of the payment transaction and the at least one predefined criteria.

14. The server system as claimed in claim 13, wherein the server system is a payment server and the server system is further caused to:
notify a digital wallet server of the preferred digital wallet application using the digital token.

15. The server system as claimed in claim 11, wherein the server system is further caused to:
receive one or more user preferences from the user device of the preferred digital wallet application to be used for making the payment transaction; and
facilitate the display of the preferred digital wallet application on the user device based on the one or more user preferences.

16. The server system as claimed in claim 11, wherein the server system is a payment server and wherein the server system is further caused to:
receive a transaction amount along with the unique reference number from an acquirer server.

17. The server system as claimed in claim 11, wherein the server system is a payment server and wherein the server system is further caused to:
extract a payment card information of the payment card associated with the unique reference number;
send the payment card information to an issuer server for authorization; and
upon successful authorization of the payment card information, perform the payment transaction.

18. The server system as claimed in claim 10, wherein the at least one predefined criteria is any one of a purchase history, one or more rewards offered by each digital wallet application, a network bandwidth utilization, and a battery usage of the user device.

19. A server system in a payment network, the server system comprising:
a memory comprising executable instructions; and
a processor communicably coupled to a communication module and configured to execute the instructions to cause the server system at least in part to:
facilitate, via the communication module, a display of an e-commerce web site configured to comprise a plurality of payment methods for a user selection on a user interface (UI) of a user device for making a payment transaction, at least one payment method of the plurality of the payment methods comprising a payment method based on a unique reference number, wherein the unique reference number is associated with a payment card linked with a plurality of digital wallet applications of a user;
receive, via the communication module, a transaction amount and the unique reference number from the user on the UI for making the payment transaction through a selection of the unique reference number based payment transaction; and
facilitate the payment transaction through a preferred digital wallet application selected from the plurality of digital wallet applications of the user using the unique reference number.

20. The server system as claimed in claim 19, wherein the server system is a merchant server and wherein the server system is further caused at least in part to:
send the unique reference number to a payment server, the payment server configured to perform the payment transaction by accessing a mapping database to extract the plurality of digital wallet applications using the unique reference number and selecting the preferred digital wallet application from the plurality of digital wallet applications of the user based on a type of the payment transaction and at least one predefined criteria, the at least one predefined criteria being usage information of each digital wallet application of the plurality of digital wallet applications.
